(19) United States
(12) Patent Application Publication
(10) Pub. No.: US 2015/0341304 A1
(43) Pub. Date: Nov. 26, 2015

(54) PERSONALIZED SHARING AT THE USER LEVEL

(71) Applicants: Corinne Elizabeth Sherman, San Jose, CA (US); Elizabeth Churchill, San Francisco, CA (US); Atish Das Sarma, Mountain View, CA (US)

(72) Inventors: Corinne Elizabeth Sherman, San Jose, CA (US); Elizabeth Churchill, San Francisco, CA (US); Atish Das Sarma, Mountain View, CA (US)

(73) Assignee: EBAY INC., SAN JOSE, CA (US)

(21) Appl. No.: 14/285,211

(22) Filed: May 22, 2014

(51) Int. Cl. H04L 12/58; H04L 29/08

(52) U.S. Cl. CPC H04L 51/32; H04L 51/08; H04L 67/306

(57) ABSTRACT

A system comprising a computer-readable storage medium storing at least one program and a computer-implemented method for generating and provisioning personalized messages is presented. Consistent with some embodiments, the method may include receiving a request from a user to share content with one or more other users. In response to receiving the request, user profile data about the user may be accessed, and a portion of the user profile data may be selected. The method may further include generating a personalized message based on the selected portion of the user profile data, and communicating the personalized message to the one or more other users.

### TECHNICAL FIELD

This application relates to data processing. In particular, example embodiments may relate to personalized content sharing services.

### BACKGROUND

Social network services (e.g., Facebook®, Twitter®, Pinterest®, or the like) provide users with the ability to post and share content of interest from third parties with members of their social network. Further, some third party websites provide users with an ability to quickly share content with members of a social network directly from a web page via a share widget that interfaces with social network services. Considering the amount of such content regularly shared on social networks, it is often difficult to share the content in a manner that will be engaging to the audience. Further, users who are sharing content may spend considerable time and effort attempting to formulate such messages.

### BRIEF DESCRIPTION OF THE DRAWINGS

Various ones of the appended drawings merely illustrate example embodiments of the present invention and cannot be considered as limiting its scope.

FIG. 1 is a network diagram depicting a network system having a client-server architecture configured for exchanging data over a network with a content publisher, according to an example embodiment.

FIG. 2 is an interaction diagram depicting example exchanges between a client device, an application server, and a third party server, consistent with some embodiments.

FIG. 3A is an interface diagram illustrating content hosted by a network-based content publisher, consistent with some embodiments.

FIG. 3B is an interface diagram illustrating an interface for facilitating the publishing of a personalized message, consistent with some embodiments.

FIG. 3C is an interface diagram illustrating a social network activity feed including a published personalized social network posting, consistent with some embodiments.

FIG. 4 is a block diagram illustrating various functional modules of a personalized sharing application, which is provided as part of the network system, consistent with some embodiments.

FIG. 5 is a flowchart illustrating a method for generating a personalized message for sharing content, consistent with some embodiments.

FIG. 6 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure include systems and methods for generating and provisioning personalized messages. Consistent with some embodiments, the personalized messages may be automatically generated by the system using information about the user for whom the message will be sent. The message may be personalized in the sense that the message may appear as though it was created by the message sender. In other words, the recipients of the message may be unable to discern that the message was not drafted (at least completely) by the message sender. The personalized messages generated by the system may be used to share content (e.g., web pages, pictures, videos, music, or the like) with others users. Accordingly, the personalized messages generated by the system may express the message sender's views toward, and relationships with, the content in a manner that is consistent with a messaging style of the message sender.

Consistent with some embodiments, the method may include receiving a request from a user to share content with one or more other users (e.g., members of the user's social network). In response to receiving the request, user profile data about the user may be accessed, and a portion of the user profile data may be selected for use in generating a personalized message. The method may further include generating a personalized message based on the selected portion of the user profile data, and communicating the personalized message to the one or more other users.

From the perspective of the user, the user may submit a request to share content, for example, via a share widget included with the content. Upon requesting to share the content, the user may identify one or more recipient users, and a manner in which the message is to be communicated to the recipient users (e.g., through text message or e-mail, or via social network). The user may then be presented with the personalized message, which may appear to the user as if he or she actually created it. The user may be prompted to approve the personalized message, and upon the user's doing so, the message is communicated to the recipient users in the manner specified by the user.

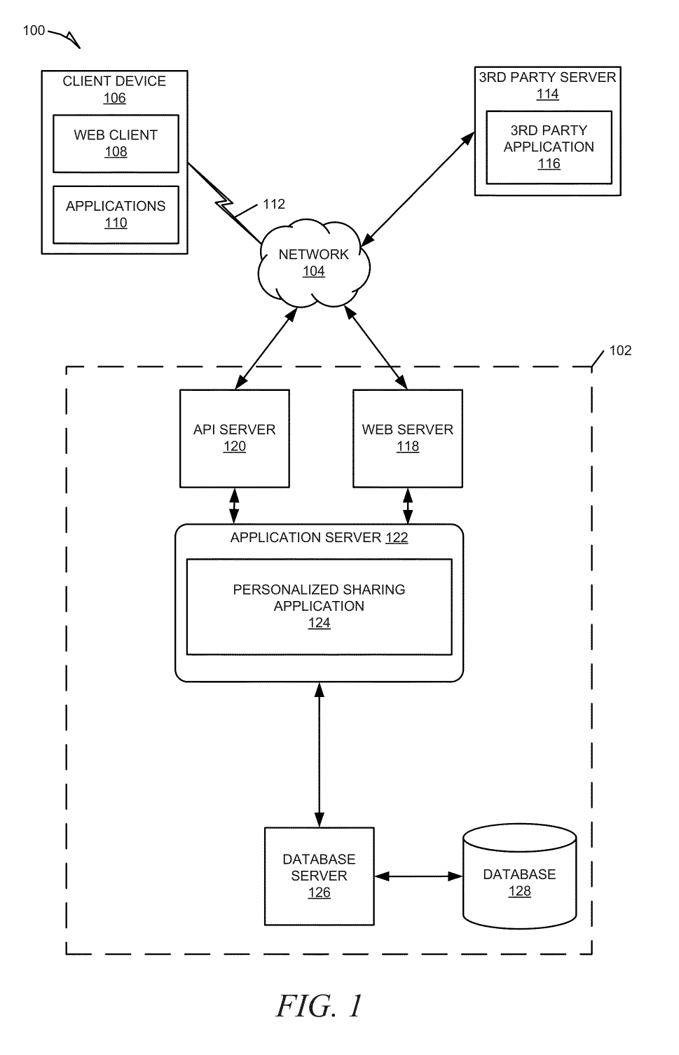

FIG. 1 is a network diagram depicting a network system 100, according to one embodiment, having a client-server architecture configured for exchanging data over a network. The network system 100 may include a network-based content publisher 102 in communication with a client device 106 and a third party server 114. In some example embodiments, the network-based content publisher 102 may be a network-based marketplace.

The network-based content publisher 102 may communicate and exchange data within the network system 100 that may pertain to various functions and aspects associated with the network system 100 and its users. The network-based content publisher 102 may provide server-side functionality, via a network 104 (e.g., the Internet), to client devices such as, for example, the client device 106. The client device 106 may be operated by a user who uses the network system 100 to exchange data over the network 104. These data exchanges may include transmitting, receiving (communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

In various embodiments, the data exchanged within the network system 100 may be dependent upon user-selected functions available through one or more client or user interfaces (UIs). The UIs may be associated with a client device, such as the client device 106 executing a web client 108. The web client 108 may be in communication with the network-based content publisher 102 via a web server 118. The UIs may also be associated with one or more applications 110 executing on the client device 106, such as a client application designed for interacting with the network-based content publisher 102, or the UIs may be associated with the third party server 114 (e.g., one or more servers or client devices) hosting a third party application 116.

The client device 106 may interface via a connection 112 with the network 104 (e.g., the Internet or a wide area network (WAN)). Depending on the form of the client device 106, any of a variety of types of connection 112 and networks 104 may be used. For example, the connection 112 may be Code Division Multiple Access (CDMA) connection, a Global System for Mobile communications (GSM) connection, or other type of cellular connection. Such a connection 112 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection 112 may be Wireless Fidelity (Wi-Fi, IEEE 802.11x type) connection, a Worldwide Interoperability for Microwave Access (WiMAX) connection, or another type of wireless data connection. In such an embodiment, the network 104 may include one or more wireless access points coupled to a local area network (LAN), a WAN, the Internet, or other packet-switched data network. In yet another example, the connection 112 may be a wired connection, for example an Ethernet link, and the network 104 may be a LAN, a WAN, the Internet, or other packet-switched data network. Accordingly, a variety of different configurations are expressly contemplated.

FIG. 1 also illustrates the third party application 116 executing on the third party server 114 that may offer one or more services to users of the client device 106. The third party application 116 may have programmatic access to the network-based content publisher 102 via a programmatic interface provided by an application program interface (API) server 120. In some embodiments, the third party application 116 may be associated with any organization that may conduct transactions with or provide services to the users of the client device 106. For example, the third party application 116 may be associated with a network based social network service (e.g., Facebook®, Twitter®, Google+®, Pinterest®, LinkedIn®, or the like) that may provide a platform for members to build and maintain social networks and relations among other members.

Turning specifically to the network-based content publisher 102, the API server 120 and the web server 118 are coupled to, and provide programmatic and web interfaces respectively to, an application server 122. As illustrated in FIG. 1, the application server 122 may be coupled via the API server 120 and the web server 118 to the network 104, for example, via wired or wireless interfaces. The application server 122 is, in turn, shown to be coupled to a database server 126 that facilitates access to a database 128. In some examples, the application server 122 can access the database 128 directly without the need for the database server 126. The database 128 may include multiple databases that may be internal or external to the network-based content publisher 102.

The application server 122 may, for example, host one or more applications, which may provide a number of content publishing and viewing functions and services to users who access the network-based content publisher 102. For example, the network-based content publisher 102 may host a marketplace application that may provide a number of marketplace functions and services to users such as publishing, listing, and price-setting mechanisms whereby a seller may list (or publish information concerning) goods or services (collectively referred to as “products”) for sale, a buyer can express interest in, or indicate a desire to purchase, such goods or services, and a price can be set for a transaction pertaining to the goods or services.

As illustrated in FIG. 1, the application server 122 hosts a personalized sharing application 124 that provides personalized content sharing services to users of the network-based content publisher 102. For example, the personalized sharing application 124 may receive requests from a user to share content with one or more other users, and in turn, the personalized sharing application 124 may generate and facilitate the communication of a personalized message to the one or more other users. Such messages are “personalized” in the sense that they include one or more phrases generated based on information about the user who issued the request to share the content. In this manner, the personalized messages may appear to the recipients (e.g., the users receiving the message) as if the messages were manually generated by the sender, as these messages may convey some information about the sender, or at least convey other information in the usual manner of the sender. The personalized message may also include a reference to the content (e.g., a link). As used herein, the terms “content” or “content item” refer to electronic data that is consumed by viewers (e.g., users) on displays, client devices or page/display-based media (e.g., World-Wide Web (WWW) media embodied in browsers and accessible over the internet). As such, the terms “content” and “content item” may refer to data associated with readable text, data associated with images, data associate with graphics or video, programmatic content, scripts, or data corresponding to various combinations of these.

The database 128 may store data pertaining to various functions and aspects associated with the network system 100 and its users. For example, user profiles for users of the network-based content publisher 102 may be stored and maintained in the database 128. Each user profile may comprise user profile data that describes aspects of a particular user. The user profile data may, for example, include demographic data, user preferences, social data, and financial information. The demographic data may, for example, include information describing one or more characteristics of a user such as gender, age, location information (e.g., hometown or current location), employment history, education history, contact information, familial relations, or user interests. The financial information may, for example, include private financial information of the user such as account number, credential, password, device identifier, user name, phone number, credit card information, bank information, transaction history or other financial information which may be used to facilitate online transactions by the user. Consistent with some embodiments, the transaction history may include information related to transactions for items or services (collectively referred to as “products”) that may be offered for sale by merchants using marketplace services provided by the network-based content publisher 102. The transaction history information may, for example, include a description of a product offered for sale, sold, or purchased by the user, an identifier of the product, a category to which the product belongs, a purchase price, a quantity, a number of bids for the product, or various combinations thereof.

The user profile data may also include a record of user activity, consistent with some embodiments. Accordingly, the network-based content publisher 102 may monitor, track, and record the activities and interactions of a user, using one or more devices (e.g., client device 106), with the various modules of the network system 100. Each user session may be stored in the database 128 and maintained as part of the user profile data. Accordingly, in some embodiments, the user profile data may include past keyword searches that users have performed, web pages viewed by each user, products added to a user wish list or watch list, products added to an electronic shopping cart, and products that the users own. User preferences may be inferred from the user activity.

While the personalized sharing application 124 is shown in FIG. 1 to form part of the network-based content publisher 102, it will be appreciated that, in alternative embodiments, the personalized sharing application 124 may form part of a service that is separate and distinct from the network-based content publisher 102. Further, while the network system 100 shown in FIG. 1 employs client-server architecture, the present inventive subject matter is, of course, not limited to such an architecture, and could equally well find application in an event-driven, distributed, or peer-to-peer architecture system, for example. The various functional components of the application server 122 may also be implemented as standalone systems or software programs, which do not necessarily have networking capabilities. It shall be appreciated that although the various functional components of the network system 100 are discussed in the singular sense, multiple instances of one or more of the various functional components may be employed.

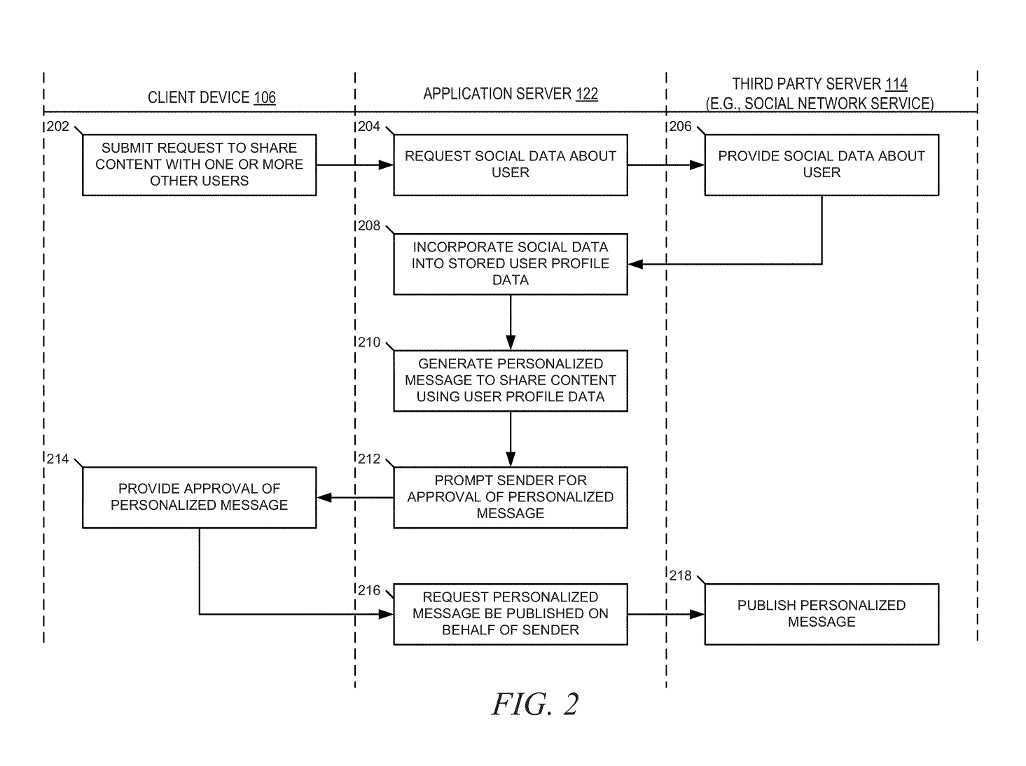

FIG. 2 is an interaction diagram depicting example exchanges between a client device, an application server, and a third party server, consistent with some embodiments. In particular, FIG. 2 depicts example exchanges between the client device 106, the application server 122, and the third party server 114, which, in this example embodiment, corresponds to a social network service. As shown, at operation 202, a user of the client device 106 (also referred to as the “message sender,” “sending user,” or “sender”) submits a request to share content with one or more other users (also referred to as “message recipients,” “receiving users” or “recipients”), who, in this example embodiment, are members of a social network of the user maintained by the social network service executing on the third party server 114.

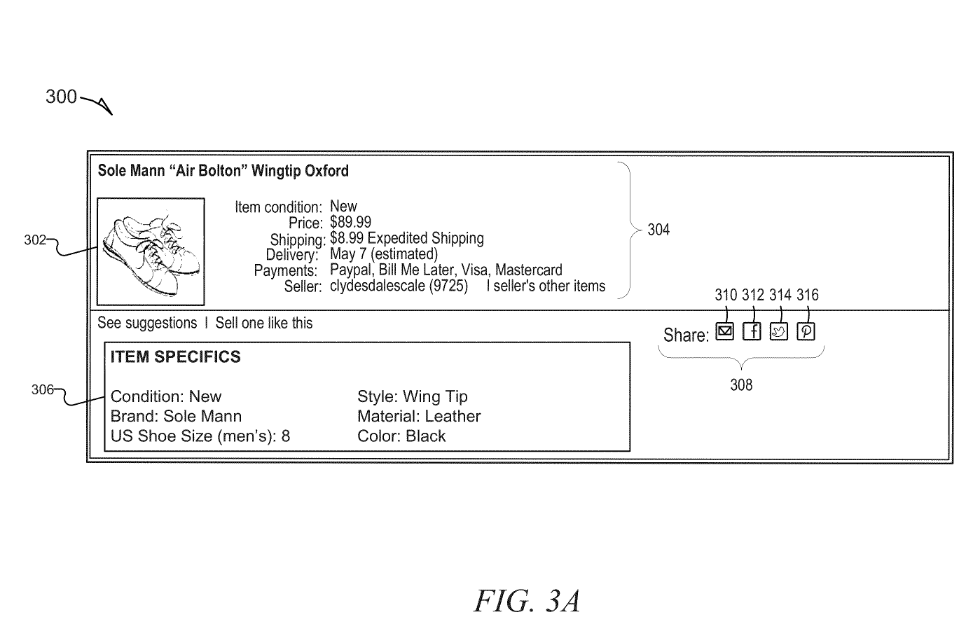

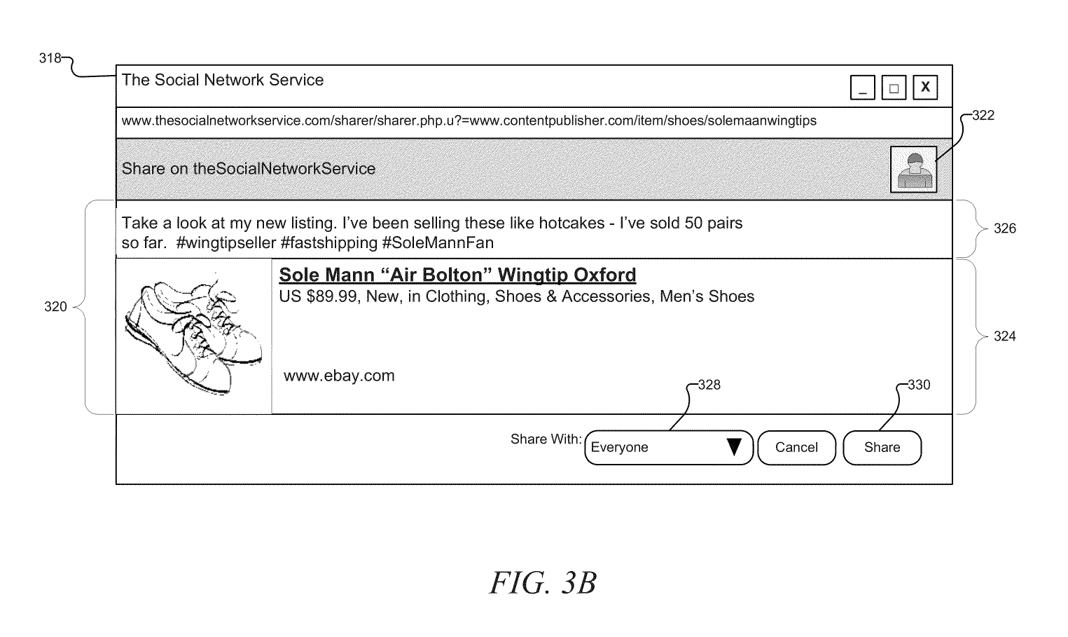

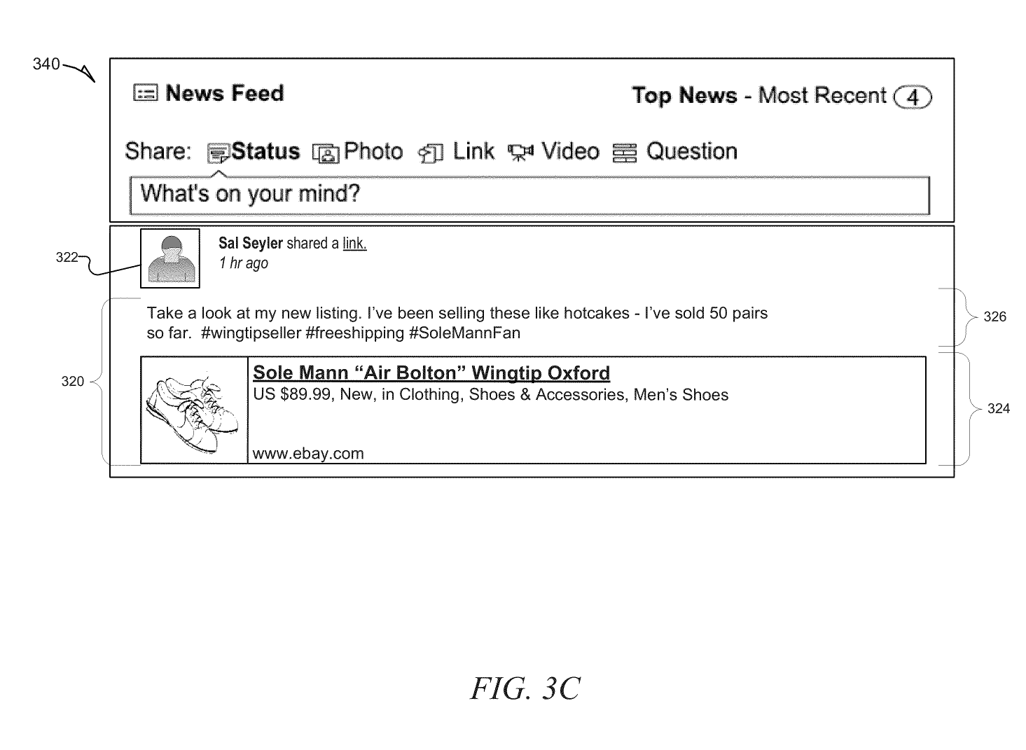

In some embodiments, the submission of the request may be via a share widget embedded in a web page hosted by the network-based content publisher 102. For example, FIG. 3A is an interface diagram illustrating content 300 hosted by the network-based content publisher 102, consistent with some embodiments. In this example embodiment, the content 300 is a marketplace listing included in a web page. As shown, the content 300 may include multiple content elements such as an image 302, a textual description 304 (e.g., a title, a price, a condition, etc.), and item attributes 306 (e.g., a condition, a brand, a size, a style, a material, and a color).

As illustrated in FIG. 3A, the content 300 also includes an embedded share widget 308 comprising buttons 310, 312, 314, and 316, each of which corresponds to a messaging platform such as electronic mail (e-mail) or a social network service (e.g., Google+®, Facebook®, Twitter®, and Pinterest®). The share widget 308 may be used by a user of the network-based content publisher 102 to trigger the generation of a personalized message for sharing the content 300 with other users such as members of the user's social network. The particular messaging platform to be utilized in sharing the content 300 depends on the user's selection of the buttons 310, 312, 314, and 316.

In shall be appreciated that the various buttons illustrated in FIG. 3A as comprising the share widget 308 are included as examples, and in other embodiments, the share widget 308 may include fewer, additional, or alternative buttons that correspond to other messaging platforms (e.g., SMS) or other social network services not specifically discussed herein. It shall further be appreciated that the share widget 308 is merely an example of a graphical user interface (GUI) element at which user requests to share content may be received, and in other embodiments, user requests to share content may be received at various other GUI elements, or from various other applications executing within the network system 100 (e.g., applications executing on the application server 122 or the third party server 114).

Returning to FIG. 2, at operation 204, the application server 122 may request social data about the sender from the third party server 114 hosting the social network service, which, in turn, provides the social data about the sender to the application server at operation 206. The term “social data” refers to information maintained by the social network service about its members. The social data of each member may contain information such as demographic information (e.g., gender, age, relationship status, employment status and history, household size), geographic information (e.g., a hometown, a current location, locations visited), interests and affinities (e.g., items the member “liked”), a list of social network connections, and a history of social network activity of the user.

For purposes of the present disclosure, a social network “connection,” also referred to as being “connected” on a social network, may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). Similarly, in the singular acknowledgement situation, a member may elect to “follow” or “watch” another member. In contrast to a reciprocal agreement, the concept of “following” another member typically is a unilateral operation because it may not call for acknowledgement or approval by the member who is being followed.

For purposes of the present disclosure, “social network activity” collectively refers to user interactions (e.g., creating, sharing, viewing, commenting on, providing feedback, or expressing interest) with entries (e.g., text and image posts, links, messages, notes, invitations, etc.). Such social network activity may involve entries that are intended for the public at large as well as entries intended for a particular social network connection or group of social network connections. Depending on the social network service, the social network activity may be published in an entry and may involve entries such as an activity feed post, a wall post, a status update, a tweet, a pin, a like, a content share (e.g., content shared from a source such as the network-based content publisher 102), or a check-in.

At operation 208, the application server 122 may incorporate the social data about the sender into the sender's user profile data maintained by the network-based content publisher 102 (e.g., stored in the database 128). Although illustrated as sequentially following the operation 202, it shall be appreciated that, in alternative embodiments, the operations 204, 206 and 208 may be performed at any time before the performance of operation 202. Furthermore, in some embodiments, the operations 204, 206, and 208 are performed on a routine basis so as to maintain accurate and up-to-date user profile data for each user of the network-based content publisher 102.

At operation 210, the application server 122 may generate a personalized message (e.g., to share the content 300) using the user profile data of the sender. From the perspective of the sender, and in some embodiments, the operation 210 is performed in response to receiving the request to share the content at operation 202. The personalized message may include a reference to the content (e.g., a hyperlink) and one or more phrases formulated based on information about the sender from the sender's user profile data. For example, the information about the user used to generate the one or more phrase may express or suggest a relationship or connection of the sender with the content being shared, or with similar content. At operation 212, the application server 122 may prompt the sender for approval of the personalized message (e.g., by providing instructions to the client device 106 to present an interface to display the personalized message and receive input from the sender).

As an example, FIG. 3B is an interface diagram illustrating an interface 318 for requesting approval of a personalized message 320 from a message sender, consistent with some embodiments. As shown, the personalized message 320 is to be published as a social network post (those skilled in the art may also refer to this as a “status update” among other names). The interface 318 may be presented in response to a selection or manipulation of one of the buttons 310, 312, 314 or 316, and may be presented over the content 300 or in a new window. As shown, the interface 318 includes an identifier of the user who will be sending the message (e.g., an image 322).

The personalized message 320 is comprised of a content reference 324 and a statement 326. The content reference 324 is a reference to the content 300 that, in some embodiments, may direct a user to the location of the content 300. In this example, the content reference 324 includes a link (e.g., www.ebay.com) that when selected by a user (e.g., by clicking or hovering over the text) redirects a browser or other mobile application executing on the client device of the user to the location of the content 300 (e.g., the webpage displaying the content 300). In other embodiments, the content reference 324 may simply identify or mention the content 300 in a manner that would be recognized and appreciated by the recipient users.

The statement 326 may comprise one or more phrases that convey information related to the content 300. The one or more phrases are formulated by the application server 122 using information about the sender contained in the user profile data of the sender. The information about the sender that is used to formulate the one or more phrases may be selected by the application server 122 based on a relationship between the sender and the content 300 conveyed by the information.

In the example illustrated by FIG. 3B, the content 300 is a marketplace listing for an item offered for sale by the sender, and published by the network-based content publisher 102 on behalf of the sender. The inclusion of the first phrase, “Take a look at my new listing,” in the personalized message 320 is based on the transaction history of the sender (e.g., included in the user profile data of the sender) indicating that the sender has previously listed items for sale using a marketplace application provided by the network-based content publisher 102. The inclusion of the second phrase, “I've been selling these like hotcakes—I've sold 50 pairs so far,” is based on a transaction history of the sender (e.g., included in the user profile data) indicating that the sender has previously sold 50 identical items (e.g., 50 “Sole Mann ‘Air Bolton’ Wingtip Oxfords”) using the marketplace application provided by the network-based content publisher 102.

As shown, the one or more phrases that comprise the statement 326 may include one or more hashtags. Hashtags typically include one or more keywords preceded by a hash or pound (“#”) sign. Hash tags may be used by search engines, social network services, content providers, online merchants, or other entities to identify and distribute content.

In the example illustrated by FIG. 3B, the personalized message 320 includes three hashtags: “#wingtipseller,” “#fastshipping,” and “#SoleMannFan.” As with the plain text phrases discussed above, the hashtags included as part of the personalized message 320 are selected by the application server 122 based at least in part on information about the sender provided by the sender's user profile data. In particular, the “#wingtipseller” hashtag is included in the personalized message 320 based on the transaction history of the sender (e.g., included in the user profile data) indicating that the sender has previously listed items for sale that have an attribute in common with the content 300, namely the previous items listed for sale and the content 300 include an attribute corresponding to “wingtip” shoes. The “#freeshipping” hashtag is included in the personalized message 320 based on the user preferences of the sender (e.g., included in the sender's user profile data) indicating that the sender ships purchased items to buyers at no additional cost. The “#SoleMannFan” hashtag is included in the personalized message 320 based on social data about the sender (e.g., included in the user profile data of the sender) indicating that the sender has expressed (e.g., through “liking” or commenting on a particular page) an interest in “Sole Mann,” the brand of the item corresponding to the content 300. In some embodiments, one or more hashtags may be included in the personalized message 320 based on information about the sender as well as additional information such as attributes of the content 300, the physical location of the sender, interests of the recipients, popular or trending hashtags, seasonality, or various combinations thereof.

As illustrated in FIG. 3B, the interface 318 may further include an input field 328 for specifying the one or more users who will be the recipients of the personalized message 320, which, in this example, corresponds to “everyone” who is a member of the social network of the sender. It shall be appreciated that although FIG. 3B illustrates the input field 328 as providing the ability to select from one or more predefined groups of members of the social network of the sender, in other embodiments, the selection of message recipients may be that of one or more individual members who may not necessarily comprise an existing predefined group, or may not necessarily be a part of a social network of the sender. The interface 318, as illustrated, also includes a button 330, which may be used to provide approval of the personalized message 320.

Returning to FIG. 2, the sender may provide approval of the personalized message (e.g., through selection of the button 330), at operation 214. Upon receiving approval from the sender, the application server 122 may transmit a request to the social network service to publish the personalized message on behalf of the sender, at operation 216.

At operation 218, the social network service may publish the personalized message on behalf of the sender (e.g., as a social network post). Upon being published by the social network service, the personalized message may be viewed by the message recipients (e.g., members of the social network of the sender). For example, FIG. 3C illustrates a social network activity feed 340 of an example recipient that includes the personalized message 320. As illustrated, the personalized message 320 may be published as a social network post appearing in the activity feed 340 of the example recipient. Within the social network post, the sender is identified by name (e.g., “Sal Seyler”) and by the image 322. The personalized message 320, as shown, includes the content reference 324 to the content 300 (e.g., a link) and the statement 326 that was formulated by the application server 122 using information about the sender from the sender's corresponding user profile data.

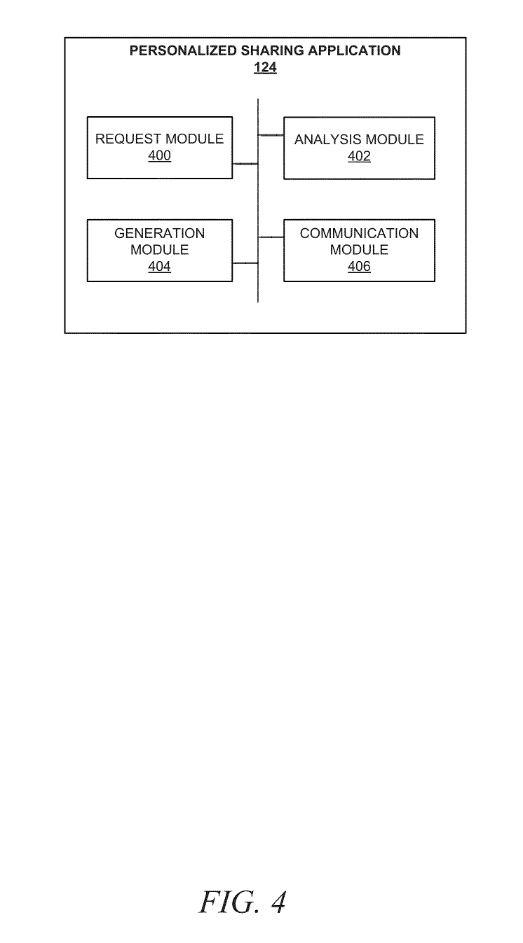

FIG. 4 is a block diagram illustrating various functional modules of the personalized sharing application 124, which is provided as part of the network-based content publisher 102, consistent with some embodiments. The personalized sharing application 124 is shown as including a request module 400, an analysis module 402, a generation module 404, and a communication module 406, all configured to communicate with each other (e.g., via a bus, shared memory, a switch, or application programming interfaces (APIs)). The various modules of the personalized sharing application 124 may, furthermore, access one or more databases 128 via the database servers 126, and each of the various modules of the personalized sharing application 124 may be in communication with one or more of the third party applications 116 (e.g., a social network service). Further, while the modules of FIG. 4 are discussed in the singular sense, it will be appreciated that in other embodiments multiple modules may be employed.

The request module 400 may be configured to receive and process user requests to share content with one or more users (e.g., the recipients). The requests may include an identifier of the content, a selected message delivery platform (e.g., email, SMS, or social network service), and an identifier of the one or more recipients (e.g., members of a social network of the sender). The identifier of the one or more recipients may include a name, an account number, a phone number, an e-mail address, a user name, or any other identifier suitable for identifying a would-be recipient of a message. Consistent with some embodiments, the user requests may be received at a share widget embedded in, or included with, content published by the network-based content publisher 102.

The analysis module 402 may be configured to analyze user profile data of a user (e.g., a message sender) to select information that may be used in generating a personalized message for sharing content. The analysis module 402 may select a portion of the user profile data that may be leveraged to formulate a coherent and relevant statement (e.g., comprising one or more phrases) that is in accordance with the sender's normal manner of communicating information (e.g., style, tone, format, and views expressed). In this manner, the personalized messages may appear to recipients as if they were actually created by the sender.

The user profile data analyzed by the analysis module 402 may be stored, for example, in the database 128, and may include demographic information (e.g., age, gender, relationship status, household size, and income level), user preferences, a transaction history, user activity, social data, and a record of user activity. The social data may be obtained (e.g., by the analysis module 402) and incorporated as user profile data on a routine basis or in response to receiving a request to share content. Social data may be obtained (e.g., via API) from each social network service for which the user has an account. The social data may include information about the user such as interests specified by the user, a history of social network activity, and additional demographic information.

In some embodiments, the analysis module 402 identifies information from the user profile data that has or is indicative of a relationship with the content being shared. Such information may be used by the generation module 404 to generate a personalized message for sharing the content. The relationship with the content may involve previous interactions, exchanges, or expressions of the user with regard to the content or similar content (e.g., content having common attributes with the content being shared). For example, the analysis module 402 may identify portions of the sender's user profile data that are representative of previously shared content that is the same as or similar to the content being shared, comments made by the sender about the same or similar content, or the sender's connection with a content generator (e.g., a social network connection).

In another example, the content being shared by the message sender is a marketplace listing offering an item for sale. In this example, the analysis module 402 may identify a portion of the user profile data of the sender representative of a purchase of the item or of purchases of items with similar attributes (e.g., category of item, brand, model, or style). In the above example, the analysis module 402 may alternatively identify a portion of the user profile data representative of sales of items with similar attributes (e.g., category of item, brand, model, or style).

In yet another example, the content being shared by the message sender is an article published by the network-based content publisher 102. In this example, the analysis module 402 may identify a portion of the user profile data of the sender representative of previous comments made by the sender with respect to other articles published by the network-based content publisher. In the above example, the analysis module 402 may alternatively identify a portion of the user profile data representative of previous articles written by the sender and published by the network-based content publisher 102.

In some instances, the information identified by the analysis module 402 may be based on a correlation of the sender's location with a geographic region commonly associated with the content or an aspect of the content. For example, a user may request to share a marketplace listing for a pair of cowboy boots the user is offering for sale. In this example, the analysis module 402 may identify that the user (e.g., the message sender) is from Texas, a region typically associated with cowboy boots.

Consistent with some embodiments, the analysis module 402 may be configured to determine a messaging style of message senders. The determination of the messaging style of a particular sender may be learned from previous messages sent by the message sender. The preferred formatting may include a font size, a font style, a diction choice, emoji use, message formality, a salutation, or various combinations thereof.

The generation module 404 may be configured to generate personalized messages using user profile data of the message sender. The personalized messages may be generated by the generation module 404 in response to user requests to share content, and the personalized messages may be used to share such content with message recipients. To this end, each of the personalized messages may include a reference to content (e.g., a link) and one or more phrases. The generation module 404 may leverage the information selected by the analysis module 402 to formulate one or more phrases to be included in a personalized message. The generation module 404 may further format the personalized message according to the messaging style of the message sender determined by the analysis module 402, consistent with some embodiments.

In some embodiments, the generation module 404 uses portions of user profile data to populate one or more templates, which result in the one or more phrases. The particular template employed may be generic, or may be selected from a collection of predefined templates based on information in the user profile data of the message sender identified by the analysis module 402. In some alternative embodiments, the one or more phrases are selected by the generation module 404 from a collection of predefined phrases based on information in the user profile data of the message sender identified by the analysis module 402.

The communication module 406 is responsible for delivery of messages (e.g., the personalized message 320) to users. The communication module 406 may utilize any one of a number of message delivery networks and platforms to deliver messages to users. For example, the communication module 406 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

In some instances, users may request that content be shared using a particular social network service. To this end, the communication module 406 may be configured to facilitate publishing personalized messages as social network postings. The communication module 406 may utilize a publically available API provided by the applicable social network service to pass information, including the personalized message, to the social network service, which ultimately publishes the personalized message as a social network posting on behalf of the sender.

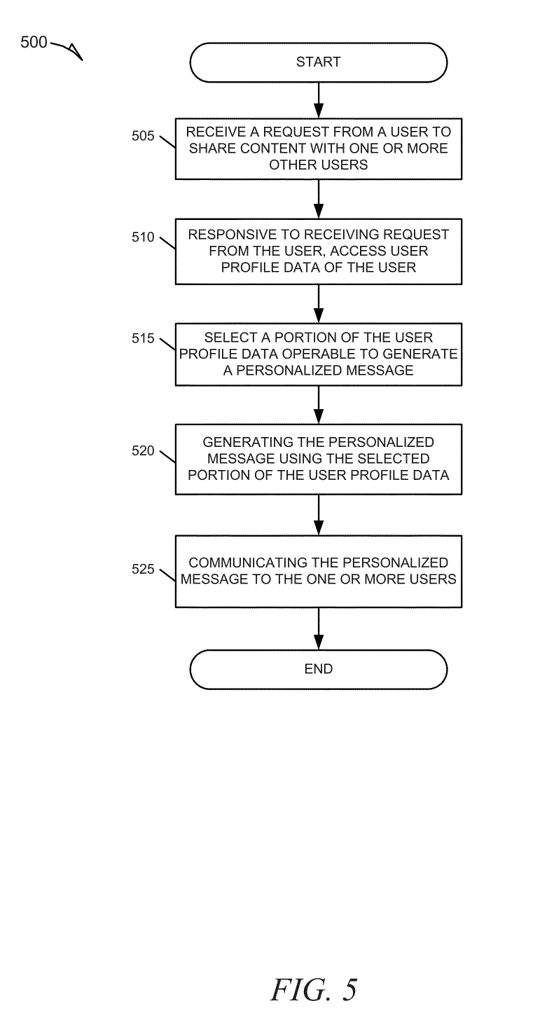

FIG. 5 is a flowchart illustrating a method 500 for providing a personalized content sharing service, consistent with some embodiments. The method 500 may be embodied in computer-readable instructions for execution by one or more processors such that the steps of the method 500 may be performed in part or in whole by the application server 122. In particular, the method 500 may be carried out by the modules forming the personalized sharing application 124, and accordingly, the method 500 is described below by way of example with reference thereto. However, it shall be appreciated that the method 500 may be deployed on various other hardware configurations and is not intended to be limited to the modules of the personalized sharing application 124.

At operation 505, the request module 400 may receive, from a client device of a user (the message sender), a request to share content with one or more other users. The one or more other users identified by the user may, for example, be members of a social network of the user. The request may, for example, be triggered by selection of a share widget (e.g., share widget 308) embedded in or included with the content. The request may specify one or more message platforms (e.g., e-mail, text messaging, or a social network) to be utilized in sharing the content.

In response to receiving the request to share content, the analysis module 402 may access user profile data (e.g., stored in the database 128) about the user (the message sender), at operation 510. The user profile data may include demographic information (e.g., age, gender, relationship status, household size, and income level), user preferences, financial information (e.g., a transaction history), social data (e.g., interests, social network connections, and affinities) and a record of user activity (e.g., click stream data, search queries performed, and content viewed).

At operation 515, the analysis module 402 may select a portion of the user profile data operable to generate a personalized message for the user (message sender). In other words, the analysis module 402 may identify information about the user that may be used to produce a message that appears as if it were created by the user (message sender). The selection of the portion of the user profile data may be a rules-based process intended to extract relevant information that may be used as a basis for formulating one or more phrases that appear as if they originated from the user. The selection of the portion of the user profile data may comprise identifying information included in the user profile data that has a relationship with the content being shared. For example, the analysis module 402 may identify a portion of the user profile data representative of a previous interaction (e.g., viewing, commenting on, or producing) with the content or similar content.

In some instances, the content being shared includes an online marketplace listing offering an item for sale. In instances in which the message sender is a potential buyer of the item, the analysis module 402 may identify portions of the user profile data of the message sender that are representative of previous purchases of similar items (e.g., same brand, style, or category of item). In instances in which the message sender is a seller of the item, the analysis module 402 may identify portions of the user profile data of the message sender that are representative of identical or similar items (e.g., e.g., same brand, style, or category of item) previously sold by the message sender.

At operation 520, the generation module 404 may, in an automated operation without further user interaction, generate a personalized message for sharing the content using the portion of the user profile data selected by the analysis module 402. The personalized message may include a reference to the content (e.g., a link) and one or more phrases based on the selected portion of user profile data. The one or more phrases may include combinations of plain text terms and hashtags. In some embodiments, the generation of the personalized message may include formatting the message according to a messaging style of the message sender.

In some embodiments, the generation module 404 may formulate unique phrases for each message sender, using the selected portion of the user profile data of the message sender. In some embodiments, the generation module 404 may use the selected portion of the user profile data to populate one or more templates to create the one or more phrases. In some embodiments, the one or more phrases are selected by the generation module 404 from a collection of predefined phrases based on the selected portion of the user profile data of the message sender.

In some instances, the one or more phrases may convey information regarding the message sender's relationship with the content. For example, assuming the content the message sender is sharing is a blog post that is among many other blog posts authored by the message sender, the personalized message may include the following phrase: “For those of you who enjoyed my previous blog post, please check out my new blog post.”

In some instances, the one or more phrases may convey information regarding a reason for the message sender sharing the content. For example, assuming the content being shared is a music video for a song by an artist the message sender has listed as one of her favorite artists in her social network profile, the personalized message may include the following phrase: “Check out this new song by Shadow Flag. I like them so much!”

At operation 525, the communication module 406 may communicate the personalized message to the one or more other users (e.g., message recipients) identified by the message sender when submitting the request to share the content. In some embodiments, the communicating of the personalized message may be subsequent to receiving the message sender's approval of the personalized message. At such time as the message sender may be prompted to provide approval of the personalized message, the message sender may be allowed to edit the personalized message. In some embodiments, the communicating of the personalized message may comprise transmitting one or more requests (e.g., API calls) to a social network service specified by the message sender.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

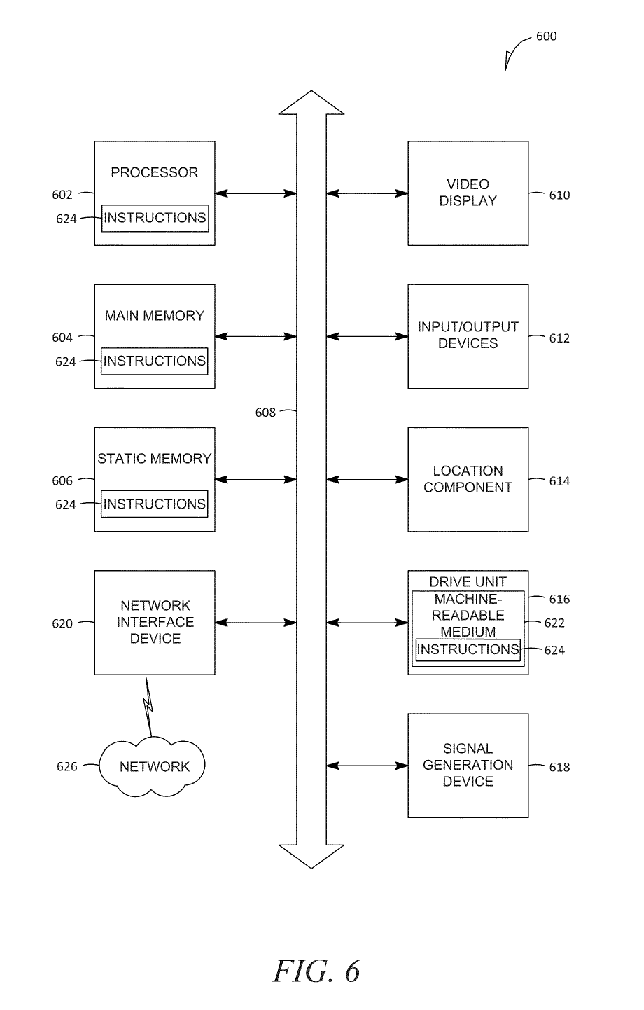

FIG. 6 is a diagrammatic representation of a machine in the example form of a computer system 600 within which a set of instructions for causing the machine to perform any one or more of the methodologies discussed herein may be executed. The computer system 600 may correspond to client device 106, third party server 114, or application server 122, consistent with some embodiments. The computer system 600 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display 610 (e.g., a liquid crystal display (LCD) or a cathode ray tube (CRT)). The computer system 600 also includes one or more input/output (I/O) devices 612, a location component 614, a drive unit 616, a signal generation device 618 (e.g., a speaker), and a network interface device 620. The I/O devices 612 may, for example, include a keyboard, a mouse, a keypad, a multi-touch surface (e.g., a touchscreen or track pad), a microphone, a camera, and the like.

The location component 614 may be used for determining a location of the computer system 600. In some embodiments, the location component 614 may correspond to a GPS transceiver that may make use of the network interface device 620 to communicate GPS signals with a GPS satellite. The location component 614 may also be configured to determine a location of the computer system 600 by using an internet protocol (IP) address lookup or by triangulating a position based on nearby mobile communications towers. The location component 614 may be further configured to store a user-defined location in main memory 604 or static memory 606. In some embodiments, a mobile location enabled application may work in conjunction with the location component 614 and the network interface device 620 to transmit the location of the computer system 600 to an application server or third party server for the purpose of identifying the location of a user operating the computer system 600.

In some embodiments, the network interface device 620 may correspond to a transceiver and antenna. The transceiver may be configured to both transmit and receive cellular network signals, wireless data signals, or other types of signals via the antenna, depending on the nature of the computer system 600.

### Machine-Readable Medium

The drive unit 616 includes a machine-readable medium 622 on which is stored one or more sets of data structures and instructions 624 (e.g., software) embodying or used by any one or more of the methodologies or functions described herein. The instructions 624 may also reside, completely or at least partially, within the main memory 604, the static memory 606, and/or within the processor 602 during execution thereof by the computer system 600, with the main memory 604, the static memory 606, and the processor 602 also constituting machine-readable media.

Consistent with some embodiments, the instructions 624 may relate to the operations of an operating system (OS). Depending on the particular type of the computer system 600, the OS may, for example, be the iOS® operating system, the Android® operating system, a BlackBerry® operating system, the Microsoft® Windows® Phone operating system, Symbian® OS, or WebOS®. Further, the instructions 624 may relate to operations performed by applications (commonly known as “apps”), consistent with some embodiments. One example of such an application is a mobile browser application that displays content, such as a web page or a user interface using a browser.

While the machine-readable medium 622 is shown in an example embodiment to be a single medium, the term “machine-readable medium” may include a single medium or multiple media (e.g., a centralized or distributed database, and/or associated caches and servers) that store the one or more data structures or instructions 624. The term “machine-readable medium” shall also be taken to include any tangible medium that is capable of storing, encoding, or carrying instructions (e.g., instructions 624) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 624 may further be transmitted or received over a network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying the instructions 624 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A system comprising:
a processor of a machine;
a machine-readable storage medium storing user profile data about a user;
a request module configured to a receive a request from the user to share content with one or more other users;
a generation module configured to generate, using the processor of the machine, a personalized message to share the content in response to receiving the request, the personalized message including a reference to the content and at least one phrase, the at least one phrase based on at least a portion of the user profile data about the user; and
a communication module configured to communicate the personalized message to the one or more other users.

2. The system of claim 1, further comprising an analysis module configured to select the portion of the user profile data based on the portion of the user profile data having a relationship with the content.

3. The system of claim 1, further comprising an analysis module configured to retrieve social data about the user from a social network service and incorporate the social data into the user profile data, wherein the social data includes interests of the user and a history of social network activity of the user.

4. The system of claim 1, further comprising an analysis module configured to determine a messaging style of the user based on previous messages drafted by the user.

5. The system of claim 4, wherein the generation module is to generate the personalized message by formatting the personalized message according to the messaging style of the user.

6. The system of claim 1, wherein the request specifies a messaging platform for sharing the content.

7. The system of claim 6, wherein the communication module communicates the personalized message to the one or more other users using the specified messaging platform.

8. A method comprising
receiving a request from a user to share content with one or more other users;
in response to receiving the request from the user, accessing user profile data about the user;
selecting a portion of the user profile data operable to generate a personalized message for sharing the content;
generating, using a hardware processor, the personalized message using the portion of the user profile data, the personalized message including a reference to the content and including at least one phrase, the at least one phrase being based on the portion of the user profile data; and
communicating the personalized message to the one or more other users.

9. The method of claim 8, wherein the request to share the content is triggered by a selection of a share widget presented in conjunction with the content.

10. The method of claim 8, wherein the one or more other users are social network connections of the user.

11. The method of claim 8, wherein the user profile data includes a transaction history of the user maintained by a network-based marketplace.

12. The method of claim 8, wherein the user profile data includes demographic and location information about the user.

13. The method of claim 8, wherein the selecting of the portion of the user profile data is based on the portion of the user profile data representing a relationship of the user with the content.

14. The method of claim 13, wherein the relationship with the content is a previous action of the user taken with respect to other content that is similar to the content.

15. The method of claim 8, wherein the generating of the personalized comprises generating a social network posting using the portion of the user profile data message is a social network posting.

16. The method of claim 8, wherein the reference to the content is a link to the content.

17. The method of claim 8, wherein the at least one phrase includes a hashtag.

18. The method of claim 15, wherein the communicating of the personalized message to the one or more other users comprises causing the social network posting to be published to a social network of the user.

19. The method of claim 8, wherein the content is a webpage corresponding to a listing of an item offered for sale.

20. A non-transitory machine-readable storage medium embodying instructions that, when executed by at least one processor of a machine, cause the machine to perform operations comprising:
receiving a request from a user to share content with one or more other users;
in response to receiving the request from the user, accessing user profile data about the user;
identifying a portion of the user profile data having a relationship with the content;
generating a personalized message using the portion of the user profile data, the personalized message including a reference to the content and including at least one phrase, the at least one phrase being based on the portion of the user profile data; and
communicating the personalized message to the one or more other users.
